(19) United States
(12) Patent Application Publication
(10) Pub. No.: US 2007/0184315 A1
(43) Pub. Date: Aug. 9, 2007

(54) Control of fuel cell stack electrical operating conditions

(76) Inventors: Sean M. Kelly, Pittsford, NY (US); John A. MacBain, Carmel, IN (US); John P. Absmeier, Rochester, NY (US)

Correspondence Address: DELPHI TECHNOLOGIES, INC., M/C 480-410-202, PO BOX 5052, TROY, MI, 48007, US

(21) Appl. No.: 11/351,123

(22) Filed: Feb. 9, 2006

(51) Int. Cl. H01M 8/04; H01M 8/24

(52) U.S. Cl. 429/23; 429/24; 429/13

(57) ABSTRACT

A fuel cell system comprising a plurality of fuel cell stacks. The stacks may be connected electrically in any sequence desired, such as in series, in parallel, or in combinations thereof or electrically independent. The electrical performance of each stack is optimized by some metric or the operating temperature of the stack is controlled by controlling the internal operating temperature of the stack, which in turn is controlled by controlling the output voltage, output current, or load of each stack independently of the other stacks. In large fuel cell systems having a large plurality of stacks, adjacent stacks may of necessity be grouped as stack pairs with joint electrical control rather than individual control, but at some sacrifice in optimal operation.

This invention was made with United States Government support under Government Contract/Purchase Order DE-FC2602NT41246. The Government has certain rights in this invention.

### TECHNICAL FIELD

The present invention relates to fuel cells; more particularly, to means for controlling the electrical output of fuel cells to drive each stack independently to its optimal operating point by some metric or a desired operating temperature given its individual air and fuel flow conditions; and most particularly, to method and apparatus for controlling the electrical operating conditions in each of a plurality of fuel cell stacks comprising a multi-stack fuel cell system. In particular, this will permit the control of fuel cell stacks in flow parallel architectures where flows are unbalanced and the control of fuel cell stacks in either series or parallel flow architectures where the stacks are not identical in performance.

### BACKGROUND OF THE INVENTION

Solid oxide fuel cells and fuel cell systems are well known. Such a fuel cell typically combines hydrogen and oxygen to generate electric voltage and current at an anode by transport of oxygen across a solid oxide electrolyte separating a cathode in an oxygen (air) atmosphere and the anode in a hydrogen/CO atmosphere, typically reformed hydrocarbons known in the art as reformate. To gain electrical output capacity, it is known to combine a plurality of individual fuel cells into a so-called fuel cell “stack” wherein the fuel cells are connected electrically in series and are supplied and exhausted in parallel with reformate and air by respective supply and exhaust manifolds. Such a fuel cell stack is known to contain, for example, 60 individual fuel cells which, in series, can produce approximately 42 volts at full load.

To minimize pressure and flow losses along the manifolds, as well as to provide a more compact fuel cell system, the total stack is commonly divided into two or more N-cell stacks, where N is a positive integer, each of which then receives separate anode and cathode gas flows in parallel, or parallel-series, although the two stacks are still connected electrically in series. Several control challenges are presented by such a design.

First, an even split of cathode and anode flow to the two N-cell stacks is dependent upon symmetric plumbing, or equal-resistance flow paths, in the feeder and exhaust paths outside the stacks.

Second, an even split of cathode and/or anode flow to the two N-cell stacks is dependent upon the relative flow resistances of each stack to anode and cathode gas flow, and these tend to vary from stack to stack. The potential impact of these first and second challenges is that the stacks may operate at different operating points, different efficiencies, different fuel utilizations, and thus may be forced as a result to each operate at a non-optimal operating condition.

Third, connecting the two 30-cell stacks in electrical series forces the two stacks to operate at the same current level. This may not provide the optimal electrical operating point for either one or both of the stacks. The rationale behind this statement is the demonstrated variability in the electrical performance of individual cells, much less 30-cell stacks.

As a result of the possibility of having two 30-cell stacks which are not matched in electrical performance, and the possibility of having the two 30-cell stacks receiving different flows of cathode and/or anode gas flow, three undesirable conditions can result:

1. The stacks may run at different power levels with different fuel utilization values and different fuel efficiency values.

2. The stacks may run at different temperatures, which further affects imbalance of electrical performance.

3. Increased parasitic power may result by requiring increased air flow to adequately cool the hotter of the two stacks to the desired operating temperature, resulting in the other stack running cooler than optimum or desired.

Larger fuel cell systems having more than two stacks operating in gas-flow parallel, or parallel-series configuration present even greater stack-to-stack optimization challenges.

In the prior art are several means for controlling stack temperature, which may be employed solely, together, or in combination with the novel method and apparatus of the present invention. The primary prior art controls include cathode air flow, anode flow (including anode air, fuel, and recycle components), and the temperatures of the stack inlet flows. The last is of course determined by the aforementioned controls coupled with the hardware of the system including primarily the heat exchangers, bypass valves, and the functionality of the reformer, as are well known in the prior art.

US Published Patent Application No. 2005/0112428 discloses a fuel cell power system comprising a plurality of fuel cell power modules, each including a fuel cell for generating electrical power. A local controller controls each fuel cell power module, and a master controller controls the local controllers. The fuel cell power modules may be electrically connected either in series or in parallel. The system may include one or a plurality of electrical bypasses connected in parallel across the respective fuel cell power modules for selectively bypassing the fuel cell power modules.

The disclosed system applies classical control of each stack via fluid flows as the sole control of the stack. An overall master controller controls the controller of each stack in conventional fashion; however, there are no details provided as to what would be commanded by the master controller; perhaps only electrical power as desired from each stack and whether it would be bypassed. Further, there is no suggestion or teaching to control the electrical performance of any stack or of the system as a whole by regulating electrical output by the controller, and thus electrically controlling average operating temperature within each stack as in the present invention.

What is needed in the art is an improved and simplified method and apparatus for controlling the electrical and thermal operation of a plurality of multiple-cell fuel cell stacks independently of one another without requiring significant change in the physical system architecture.

It is a principal object of the present invention to provide improved electrical performance and fuel efficiency in a multiple-stack fuel cell system.

### SUMMARY OF THE INVENTION

Briefly described, a fuel cell system in accordance with the invention comprises a plurality of fuel cell stacks which may be electrically connected in any sequence desired. The electrical performance of each stack is optimized by controlling the internal operating temperature of the stack, which in turn is controlled by controlling the output voltage, output current, or load of each stack independently, which parameters are the controller inputs. Circuitry for providing such control is known in the prior art and may comprise a current or voltage modulating input conditioning device and a DCDC converter and DC or AC output stage supplying conditioned, appropriate phase current and voltage to a DC or AC load. In large fuel cell systems having a large number of stacks, adjacent stacks may of necessity be connected electrically in series or parallel by groups or pairs rather than individual electrical control, but at some potential sacrifice in optimal operation.

### BRIEF DESCRIPTION OF THE DRAWINGS

The present invention will now be described, by way of example, with reference to the accompanying drawings, in which:

FIG. 1a is a schematic drawing of a prior art arrangement for electrical control of a fuel cell system comprising a single fuel cell stack;

FIG. 1b is a schematic drawing of a prior art arrangement for electrical control of two fuel cell stacks arranged in parallel flow in a two-stack fuel cell system;

FIG. 2 is a schematic drawing of a first embodiment in accordance with the invention for improved electrical and performance control of the two-stack parallel flow fuel cell system shown in FIG. 1b;

FIG. 3 is a schematic drawing of a second embodiment for improved electrical control of the two-stack system shown in FIG. 1b wherein the two stacks are arranged in serial flow;

FIG. 4 is a schematic drawing of a third embodiment for improved electrical control of a four-stack system comprising two two-stack legs wherein the stacks within the legs are arranged in serial flow and wherein the two legs are arranged in parallel flow;

FIG. 5 is a schematic drawing of a first alternate control scheme for the four-stack system shown in FIG. 4; and

FIG. 6 is a schematic drawing of a second alternative control scheme for the four-stack system shown in FIG. 4.

Corresponding reference characters indicate corresponding parts throughout the several views. The exemplifications set out herein illustrate several preferred embodiments of the invention. Such exemplifications are not to be construed as limiting the scope of the invention in any manner.

### DESCRIPTION OF THE PREFERRED EMBODIMENTS

The advantages and benefits of the invention may be better appreciated by first considering two prior art systems for controlling the electrical output and operating temperature of a fuel cell system.

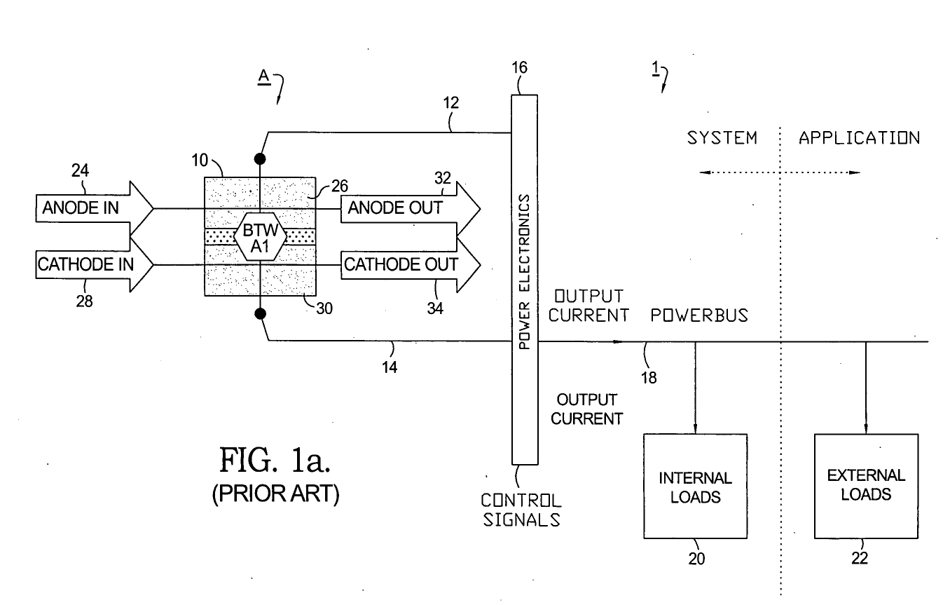

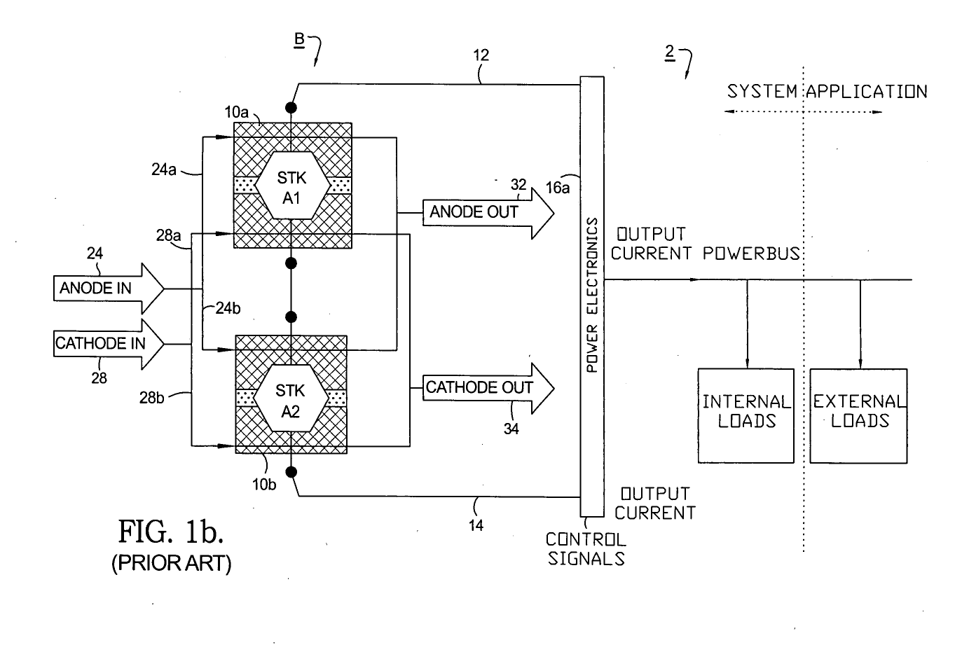

Referring to FIG. 1a, in a prior art control system 1 for a first fuel cell system A, the operating temperature of a single fuel cell stack 10, for example a 30-cell stack, can be controlled by the electrical connection of stack 10 through anode and cathode leads 12,14 to power electronic controller 16 and thence to a power bus 18 supplying the system's internal parasitic loads 20 and external application loads 22. Stack 10 is supplied with fuel 24 to the anode 26 and with air 28 to the cathode 30. Respective exhaust flows are anode exhaust 32 and cathode exhaust 34. Stack 10 is a single stack of multiple conventional fuel cells, for example, solid oxide fuel cells as described above.

Since the power electronic controller 16 can control either the voltage or the current of its input ports, which is stack 10, the level of heat generation within the stack can be controlled. This voltage or current control can be applied as a means to control the average operating temperature of the stack. This can be useful as an additional or alternative means to control stack operation when combined with the other controls that are readily available, as recited above. The circuitry in power electronic controller 16 (as well as in all the novel embodiments described below) for controlling input voltage or current is known in the art, as described below.

If the stack temperature were to rise dangerously, the electrical load can be quickly reduced, causing an immediate drop in the transport of oxygen ions across the electrolyte and a consequent reduction in the chemical reaction of oxygen ions and fuel in the anode stream, allowing very rapid contraction of stack heat production. This control does not experience the transport delay accompanying the other controls noted above.

Controlling the electrical output can also place the stack at its desired optimal operating point for the anode and cathode gas flows that it is receiving. “Optimal operating point” here can be determined by a variety of metrics, two examples of which would be maximizing electrical power generation and achieving a desired fuel utilization level.

Referring to FIG. 1b, in a second prior art control system 2 for a second fuel cell system B, first and second multiple-cell fuel cell stacks 10a, 10b are connected conventionally in electrical series through anode and cathode leads 12,14 to power electronic controller 16a. Stacks 10a, 10b are arranged as first and second legs in parallel gas flow for anode fuel 24, cathode air 28, anode exhaust 32, and cathode exhaust 34.

The thermal and electrical control problems inherent in the prior art arrangement shown in FIG. 1b have been described above. Power electronic controller 16 still regards the two stacks 10a, 10b as a single electrical entity and cannot adjust the electrical performance of either stack independent of the other.

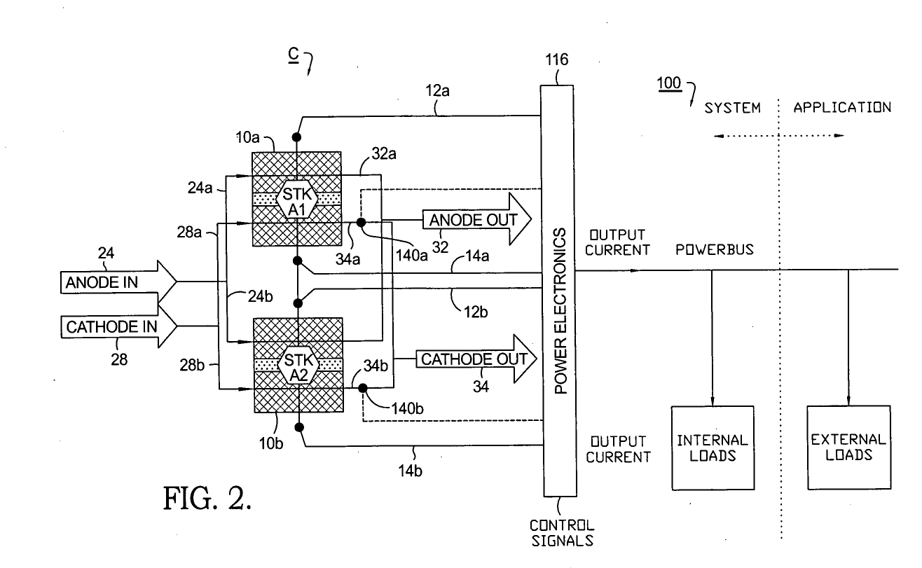

Referring to FIG. 2, in a first improved control system 100 for a dual-stack system C similar to prior art system B, stacks 10a, 10b are connected electrically independently (leads 12a, 12b, 14a, 14b) to an improved power electronic controller 116 which can control either the current or the voltage in either stack independently of the other, as described below. In a presently preferred embodiment, the primary control of the fuel cell system still relies upon non-electrical prior art control features as recited above. However, the operating temperature of each multiple-cell fuel cell stack 10a, 10b may be controlled and therefore optimized independently to optimize the electrical output Preferably, temperature sensors 140a, 140b in either the individual anode exhaust streams 32a, 32b or the individual cathode exhaust streams 34a, 34b can supply information to the power electronic controller 116 concerning the operating temperature internal to each of stacks 10a, 10b, respectively.

Controlling each stack 10a, 10b by specifying its voltage or current through measurement of average operating temperature accomplishes two goals. First, temperature can be controlled solely using power electronics subject to the given anode and cathode flow conditions. If the indicated temperature of a stack drifts outside predetermined limits (determined by safety with dangerous conditions identified and/or known optimal temperature operating range), the temperature of that stack can be adjusted by adjusting its electrical operating point. Second, since any two stacks will react differently, from an electrical standpoint, even if they receive identical anode and cathode flows 24a, 24b, 28a, 28b, the imbalance in electrical response to the input gas flows can be altered to maintain each stack at its own preferred optimal operating point (combination of temperature and electrical parameters including voltage, current, and/or power). As such, with control logic in the power electronics packages the electrical power output of each stack could be maximized by controlling the voltage or current output of each stack independently subject to the given anode and cathode flow conditions in each stack, effectively maximizing the electrical power output of the total system.

The general arrangement of circuitry (not shown) in power electronic controller 116 is known in the prior art and is applicable as well in power electronics 216,316,416,516 as described below. The input terminals of the power electronics module represent two current or voltage modulating input power conditioner blocks, one connected across stack 10a and the other connected across stack 10b. The power conditioner blocks can control either the input current or the input voltage from stacks 10a, 10b independently. In practice, the power electronics often controls the input current to the input power conditioners, but in the case of voltage control they could sense the current and alter the voltage to drive the input voltage to a targeted value or to seek a voltage that yields maximum power or to optimize a variety of other metrics or as noted to prevent migration of the current or voltage beyond prescribed limits.

The output of each input power conditioner block feeds into a DCDC converter and DC or AC output stage. The voltage converters can output at different voltages, or else can output at the same voltage so the two outputs are joined into a common circuit. If AC output is desired, other control may be required to place the two output units in phase. In the case of DC output, additional control or communication may be required so the output voltage targets can be common.

FIG. 2 (and all subsequent figures) show the output of the power electronics module being to a common power bus. Since multiple (2) blocks of power electronics are present power in electronics block 116, their relative outputs could be combined as shown or separately output to various internal and/or external loads as design motivations dictate. Such various outputs could be at different voltages and of different voltage waveforms as required.

The overall fueling is controlled in the traditional manner to target overall electrical power output. The control function of the power electronics allows the adjustment of the electrical current or voltage from stack 10a and stack 10b to the respective power conditioner to move the individual stack operating temperatures to desired levels, or to move their operation to an optimal setting by some other metric, for example, fuel utilization or total electrical power, as desired, independently from one another. This supercedes the capabilities of prior art controls wherein common flows are established and performance of each stack results from hardware differences in flows and the inherent differences in stack capabilities.

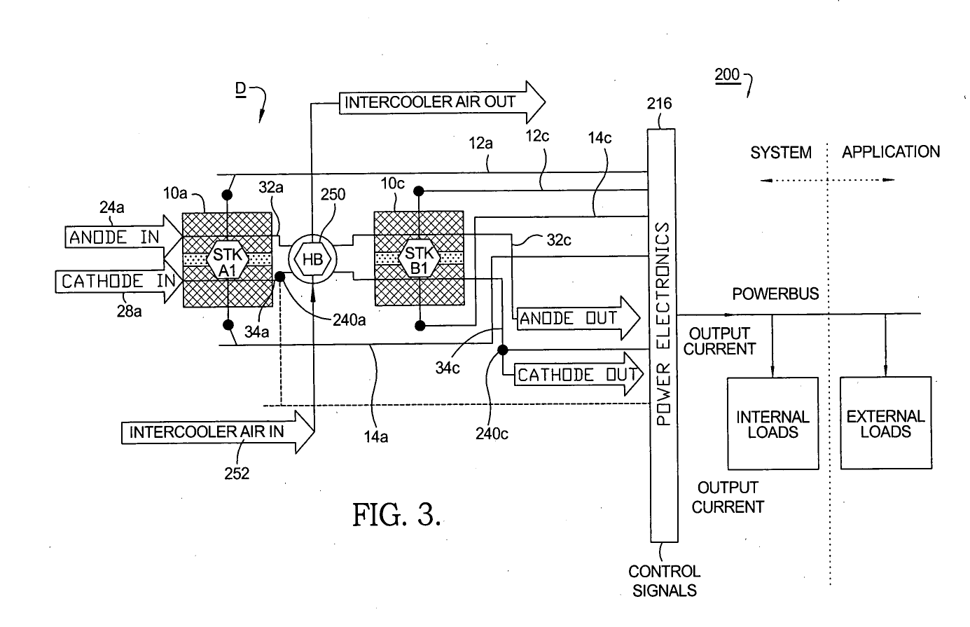

Referring to FIG. 3, another dual-stack fuel cell system D having a control system 200 in accordance with the invention comprises stacks 10a, 10c. Stacks 10a, 10c are connected individually via leads 12a, 12c, 14a, 14c to power electronic controller 216 and are arranged in series flow for anode fuel 24 and for cathode air 28. Upon exiting stack 10a, each exhaust stream 32a, 34a preferably is passed through an intercooler 250 supplied with cooling air 252 such that the exhaust streams 32a, 34a are tempered to, preferably, the inlet temperatures of streams 24a, 28a before entering stack 10c in serial flow with stack 10a. Thus, stacks 10a, 10c are arranged in series flow of anode fuel and cathode air but are independently controllable electronically.

To enable independent temperature control of stacks 10a, 10c, individual temperature sensors 240a, 240c in either the individual anode exhaust streams 32a, 32c (not shown) or the individual cathode exhaust streams 34a, 34c can supply information to power electronic controller 216 concerning the operating temperature internal to each of stacks 10a, 10c, respectively.

An advantage of system D is that fuel efficiency is greatly improved over system B because significant amounts of fuel and oxygen are not consumed in stack 10a and are thus available for additional electricity generation by being reacted in stack 10c. Further, this additional level of control is desirable, for stacks 10a and 10c receive different flow rates and composition of anode and cathode flow, and thus require control to both run at desirable operating points.

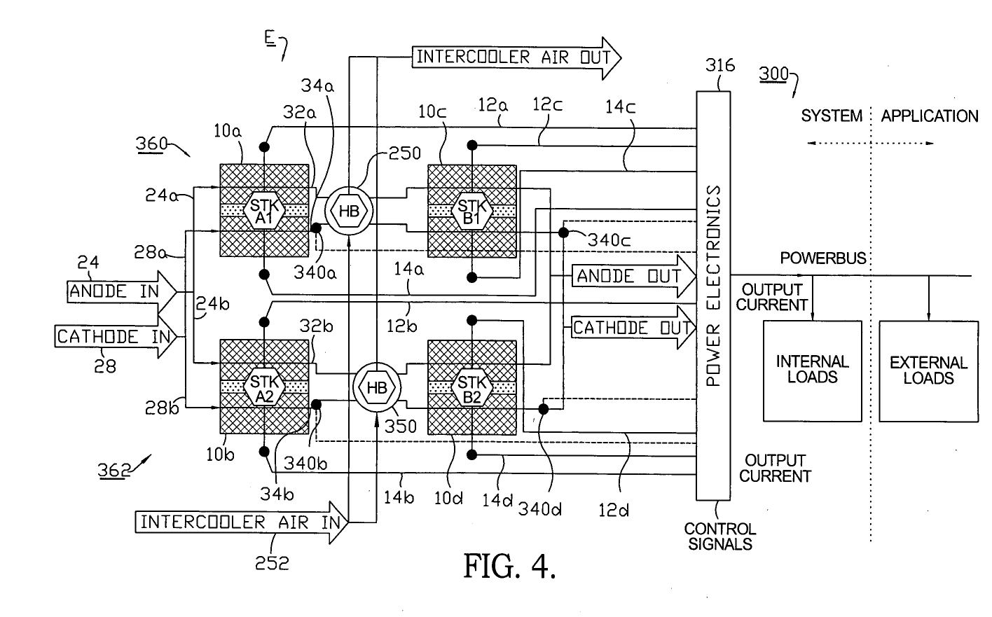

Referring to FIG. 4, another multi-stack fuel cell system E having a control system 300 comprises stacks 10a, 10b as in system B and additionally stacks 10c and 10d for double the power capacity. Stacks 10a, 10b are connected individually via leads 12a, 12b, 14a, 14b to power electronics 316, and stacks 10c, 10d are also connected individually via leads 12c, 12d, 14c, 14d to power electronic controller 316. Stacks 10a, 10c are arranged in series flow for anode fuel 24a and for cathode air 28a. Upon exiting stack 10a, each exhaust stream 32a, 34a preferably is passed through a first intercooler 250 supplied with cooling air 252 such that the exhaust streams 32a, 34a are tempered to, preferably, the inlet temperatures of streams 24a, 28a before entering stack 10c in serial flow with stack 10a. A similar arrangement is provided between stack 10b and stack 10d, using a second intercooler 350 also supplied with cooling air 252. Thus, stacks 10a, 10c are arranged in series flow of anode fuel and cathode air but are independently controllable electronically; and similarly, stacks 10b, 10d are arranged in series flow of anode fuel and cathode air but are independently controllable electronically. Stacks 10a, 10c define a first flow leg 360 of system E, and stacks 10b, 10d define a second flow leg 362 of system E, wherein legs 360, 362 are connected in parallel gas flow.

System E enjoys the fuel efficiency conferred by serial flow of fuel and oxidant through each leg and double the power output of systems C or D. Systems comprising additional parallel legs, while not shown specifically herein, will be obvious to one of ordinary skill in the art and are fully comprehended by the invention.

System E shows separate electronics control of each of the four stacks 10a, 10b, 10c, 10d. Each such control can be configured to control either the voltage or the current for the stack to which it is connected for input. To enable independent temperature controls of the stacks, temperature sensors 340a, 340b, 340c and 340d in the individual cathode or anode exhaust streams (cathode exhaust streams shown) supply information to power electronic controller 316 concerning the operating temperatures internal to each stack.

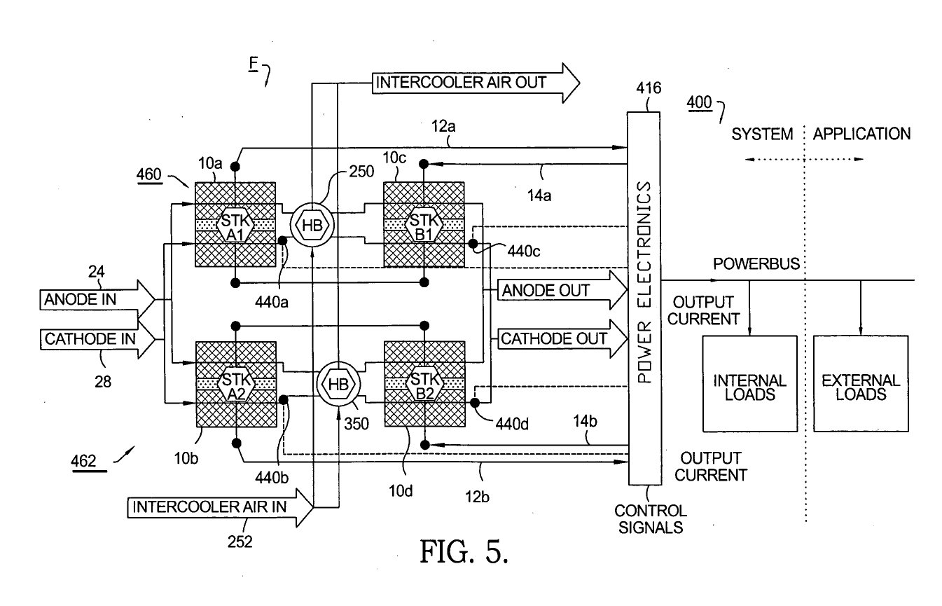

Referring now to FIG. 5, in another four-stack fuel cell system F in accordance with the invention having a control system 400, the two stacks 10a, 10c and 10b, 10d in series flow in each flow leg 460, 462, respectively, may be connected electrically in series via leads 12a, 12b, 14a, 14b, each leg connecting to a single controller in power electronic controller 416. This simplified control arrangement requires only one temperature probe 440a, 440b in each leg (cathode exhaust streams shown) for control although additional probes 440c, 440d can be useful for monitoring the status of the downstream stacks 10c, 10d. Although some control flexibility is sacrificed when the four stacks are connected this way, the serial stack pairs have the same current, and the power electronics can control either that current directly or can control the total series voltage of the two serial stack pairs.

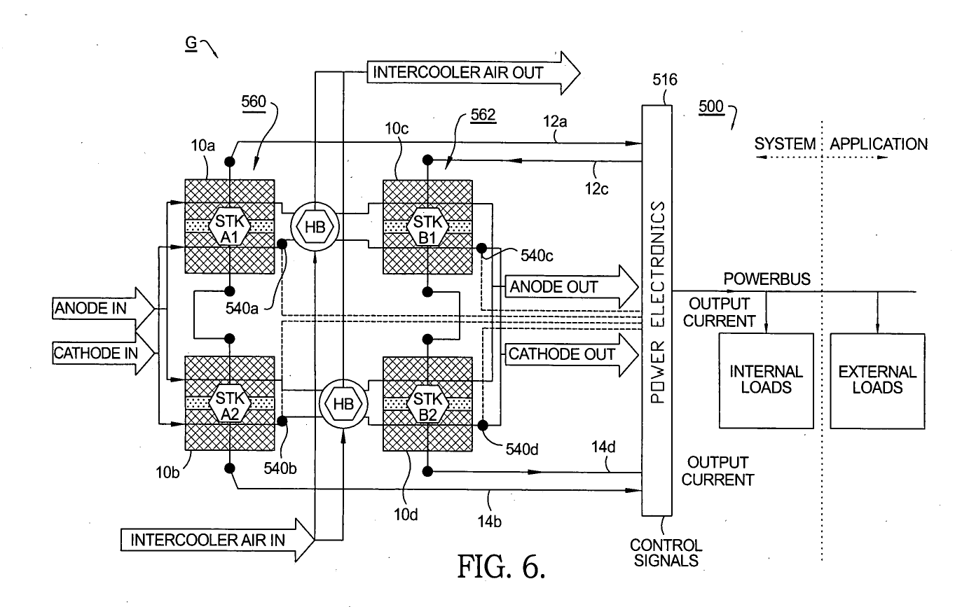

Referring now to FIG. 6, in another four-stack fuel cell system G in accordance with the invention having a control system 500, upstream stacks 10a, 10b may be connected electrically in series and connected via leads 12a, 14b to power electronic controller 516 as a first stack pair sharing a common current level and controlled by specifying either the current or the series voltage across stack pairs 10a, 10b, defining a first electrical leg 560. Likewise the two downstream stacks 10c, 10d may be connected via leads 12c, 14d in series sharing a common current; again, power electronic controller 516 can control either the current directly or the series voltage across stack pairs 10c, 10d, defining a second electrical leg 562. This control arrangement requires only one temperature probe 540a, 540c in each leg (cathode exhaust streams shown) for control although additional probes 540b, 540d can be useful for monitoring the status of stack pairs 10b, 10d.

Although not specifically shown, the invention contemplates pairs or groups of stacks being electrically connected in parallel prior to connection to the power electronics block.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A fuel cell system comprising:
a) a plurality of fuel cell stacks; and
b) an electronic controller for controlling electric input to said electronic controller from said plurality of fuel cell stacks,
wherein said electric input from each stack is controlled by said electronic controller independently of the electric inputs from the other of said stacks in said plurality of fuel cell stacks.

2. A fuel cell system in accordance with claim 1 wherein each of said stacks includes a plurality of individual fuel cell units.

3. A fuel cell system in accordance with claim 1 wherein said electric input to said controller is selected from the group consisting of electric load, voltage and current.

4. A fuel cell system in accordance with claim 1,
wherein a fuel gas is passed through an anode side of each stack, and
wherein air is passed through a cathode side of each stack, and
wherein each of said stacks further comprises a temperature probe disposed in an outlet gas stream from said stack, said temperature probe being connected to said controller to indicate an operating temperature within said stack.

5. A fuel cell system in accordance with claim 1 wherein said electronic controller includes;
a) an input power conditioner block for modulating said electrical input;
b) a DC-DC converter; and
c) a current output stage selected from the group consisting of AC and DC output.

6. A fuel cell system in accordance with claim 1 wherein said plurality of fuel cell stacks are connected together for flow of gas therethrough in a mode selected from the group consisting of serial, parallel, and combinations thereof.

7. A fuel cell system in accordance with claim 1,
wherein the number of stacks in said plurality of stacks is four, and
wherein first and second of said stacks are connected in series for flow of gas therethrough, defining a first leg, and
wherein third and fourth of said stacks are connected in series for flow of gas therethrough, defining a second leg, and
wherein said first and second legs are connected in parallel for flow of gas therethrough.

8. A fuel cell system comprising:
a) a plurality of fuel cell stacks; and
b) an electronic controller for controlling electric input to said electronic controller from said plurality of fuel cell stacks,
wherein pairs of said stacks are electrically connected in series, and
wherein said electric input from said stack pairs is controlled by said electronic controller independently of the electric inputs from other stack pairs in said plurality of fuel cell stacks.

9. A method for controlling the electrical operating conditions of a plurality of fuel cell stacks in a multi-stack fuel cell system supplied with anode fuel and cathode air, comprising the steps of:
a) connecting said fuel cell stacks for flow of anode fuel and cathode air therethrough in a mode selected from the group consisting of series, parallel, and combinations thereof;
b) connecting each of said fuel cell stacks to an electronic controller for regulating an input electrical parameter; and
c) adjusting said selected electrical parameter at said electronic controller in accordance with a target value.

10. A method in accordance with claim 9 wherein said input electrical parameter is selected from the group consisting of input voltage and input current from said each fuel cell stack to said electronic controller;

11. A method in accordance with claim 9 further comprising the steps of:
a) providing a temperature sensor in a selected one of an anode exhaust stream or a cathode exhaust stream from each of said fuel cell stacks for sensing the temperature thereof, said temperature sensor being operationally connected to said electronic controller;
b) setting an aim temperature range for said selected exhaust stream; and
c) varying said input electrical parameter to maintain said sensed temperature within said aim temperature range.

12. A method for controlling the electrical operating conditions of a plurality of fuel cell stacks in a multi-stack fuel cell system supplied with anode fuel and cathode air, comprising the steps of:
a) connecting said fuel cell stacks for flow of anode fuel and cathode air therethrough in a mode selected from the group consisting of series, parallel, and combinations thereof;
b) connecting each of said fuel cell stacks to an electronic controller for regulating an input electrical parameter; and
c) adjusting said selected electrical parameter at said electronic controller in accordance with an optimal operating point.

13. A method in accordance with claim 12 wherein said optimal operating point is maximum output electrical power.

14. A method in accordance with claim 12 wherein said optimal operating point is a desired fuel utilization level.

15. A method in accordance with claim 12 wherein said optimal operating point is a desired stack voltage level.

16. A method in accordance with claim 12 wherein said optimal operating point is a desired stack current level.

17. A method in accordance with claim 12 wherein said optimal operating point is a desired stack electrical power level.
